(19) United States
(12) Patent Application Publication
(10) Pub. No.: US 2002/0088133 A1
(43) Pub. Date: Jul. 11, 2002

(54) Elastic spacing cord

(76) Inventor: David McMillan, Momence, IL (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/755,647

(22) Filed: Jan. 5, 2001

(51) Int. Cl. G01B 3/10

(52) U.S. Cl. 33/756; 33/413

(57) ABSTRACT

A spacing device having a length of uniformly stretchable elastic cord pre-marked with equally spaced marks in a manner such that when the cord is stretched across a given span to be divided into equal spaces, the distance between any two marks will be equal to the distance between each of the marks on the cord within the span, thereby providing a quick reference of one or more equally spaced points within a given span. In one embodiment the elastic cord is wound about a reel, and in another embodiment, the cord may be dispensed from the reel. To divide a span equally by a given number of spaces, the elastic cord is adjusted elastically to provide the location of one or more of the points. To locate equally spaced points along a line, the elastic cord is adjusted elastically to provide the desired spacing and the location of those points.

### TECHNICAL FIELD

This invention relates to devices for determining spacing, and, in particular, to an elastic cord marked with indicia for quickly determining one or more equally spaced points or to establish the desired spacing of those points within a given span or along a straight line.

### BACKGROUND OF THE INVENTION

Heretofore, measuring devices such as tape measures or coilable rules have been provided for use in determining the length of a given distance. To divide that distance or a straight line into equal spaces, the user is limited to mathematically dividing the total span length into the desired equal spaces. The tape measure offers measurements within the overall span distance. It does not offer an easily determined indication of the equally spaced points within that span or along a line other than the 12″ or 16″ increments indicated on most tapes. The tape measure also does not offer the means to quickly adjust the distance between the equally spaced points to meet a desired prescribed spacing.

Heretofore, for example, a carpenter requiring a quick indication of the points on which to position 1-inch-thick spindles spaced 4 inches or less between each spindle on a given length of rail between two posts was limited to the use of a tape measure to measure the overall length and mathematically subtract the thickness of each spindle then divide the remaining length by 4 inches. A carpenter relying on a length of wood pre-cut to 4 inches as a guide to space the spindles will be limited to adjusting the distance between the last few spindles to a length greater than or less than the 4-inch requirement when the installation involves a span with an overall length that is not equally divisible by 4 inches. In order to avoid the time-consuming mathematical calculations of feet and inches, or any other linear measurement, or unequal spacings of odd-length spans, it is necessary to provide a quick and accurate method of equally dividing the overall length.

Similarly heretofore, for example, an airframe technician drilling holes for rivet installation and requiring a quick indication of points equally spaced 4½ inches along a line, is limited to the use of a tape measure to measure the overall length and mark off each point that is divisible by 4½ inches. In order to avoid this procedure, one that is both time consuming and prone to mathematical error, it is necessary to provide a quick and accurate method of equally dividing the overall length.

No device is known in prior art disclosures that provides a pre-marked elastically adjustable cord to determine equally spaced points within a given span or along a line.

### SUMMARY OF THE INVENTION

The disclosed embodiment of the present invention avoids the limitations inherent in prior devices and methods by providing a spacing device having a length of elastic cord pre-marked with equally spaced indicia in a manner such that when stretched across a given span to be divided into equal spacings the distance between any two marks will be equal to the distance between each of the marks on the cord within the span, thereby providing a quick reference of one or more equally spaced points within a given span or along a line. The embodiment of the present invention also avoids the limitations inherent in prior devices by allowing the distance between each space to be adjusted elastically to meet a desired spacing.

More specifically, the disclosed embodiment of the present invention may be summarized as directed to a length of elastic cord pre-marked with equally spaced marks. The cord is typically stored on a reel and may be housed in any suitable housing or casing. The outer end of the cord is fitted with a hook or fastening means to attach one end of the cord to a fixed point at one end of the span to be divided into equal spaces. The elastic cord is unwound from the reel across the span in a straight line and stretched as necessary until a mark on the cord is positioned on a point at the other end of the span to be divided. The reel or housing may then be secured to the work surface with a nail through a hole in the reel or housing. From the equally spaced marks on the cord, the user is able to determine the location of one or more points that equally divide the total span.

The present invention contemplates a novel means to divide a given span by a given number of spaces. The pre-marked cord can be adjusted elastically to establish the desired spacing and to provide the location of the points equally dividing that span.

The disclosed embodiment of the invention provides a length of elastic cord pre-marked with equally-spaced marks in a manner such that when stretched across a given span to be divided into equal spaces, the distance between any two marks will be equal to the distance between each of the marks on the cord within the span, thereby providing a quick reference of one or more equally spaced points within a given span.

Another aspect of the disclosed embodiment of the invention is to provide a length of elastic cord pre-marked with equally spaced marks in a manner such that when stretched across a given span to be divided into a given number of spaces, the cord can be adjusted elastically to provide the location one or more points equally dividing that span.

Another aspect of the embodiment of the invention is to provide a length of elastic cord pre-marked with equally spaced marks in a manner such that when stretched along a line, the cord can be adjusted elastically to establish the desired spacing and to provide the location of one or more equally divided points along that line.

In accordance with another embodiment of the invention, a length of elastic cord pre-marked with equally spaced indicia that is stored on a spool and housed in a suitable housing or casing is provided.

In accordance with still another aspect of the invention, a length of elastic cord fitted on one end with a clip or fastening means for attachment to a fixed point at one end of the span to be divided into equal spaces or at one end of a line to be divided into equal spaces is provided.

To attain these features and such further features and advantages as may appear herein or be hereinafter pointed out, reference is made to the accompanying drawings, the following description, and the appended claims.

### BRIEF DESCRIPTION OF THE INVENTION

The foregoing and other features and advantages of the present invention will be more readily appreciated from the following detailed description when taken in conjunction with the accompanying drawings, wherein:

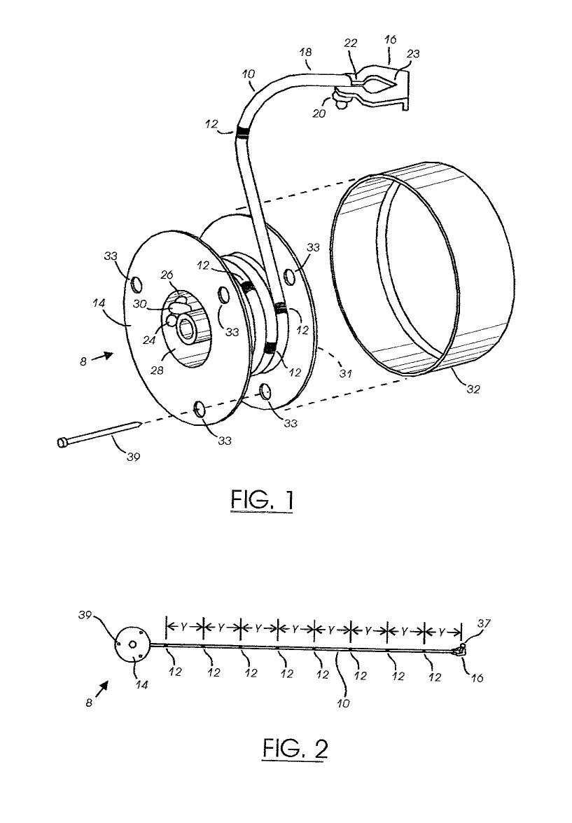

FIG. 1 is an isometric view of a representative embodiment of the present invention;

FIG. 2 is a plan view of the device of FIG. 1 with the pre-marked elastic cord stretched and secured at each end;

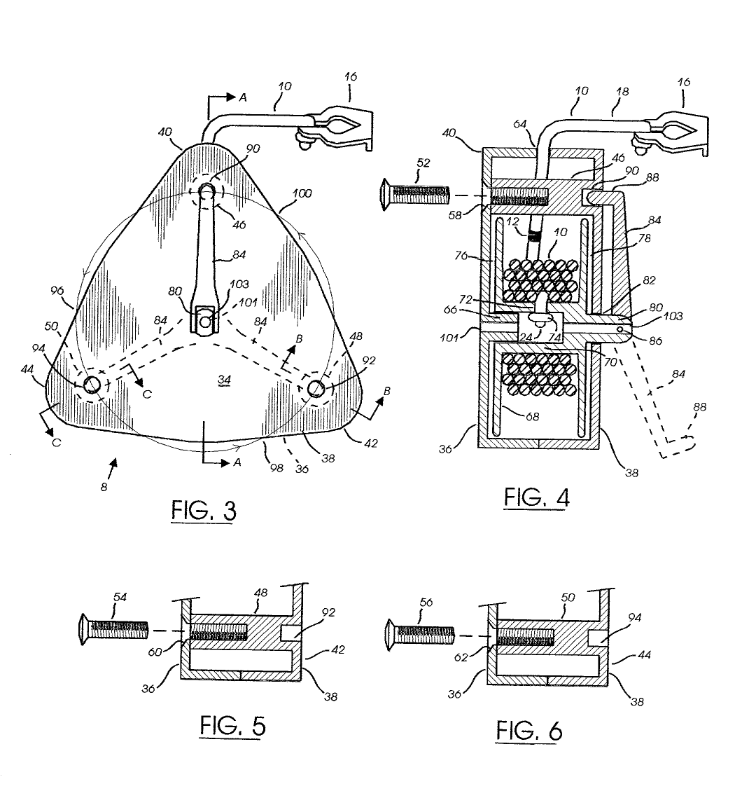

FIG. 3 is a plan view of a further representative embodiment of the present invention;

FIG. 4 is a longitudinal sectional view taken on the plane of section indicated by the line A-A of FIG. 3;

FIG. 5 is a longitudinal partial sectional view taken on the plane of section indicated by the line B-B of FIG. 3;

FIG. 6 is a longitudinal partial sectional view taken on the plane of section indicated by the line C-C of FIG. 3;

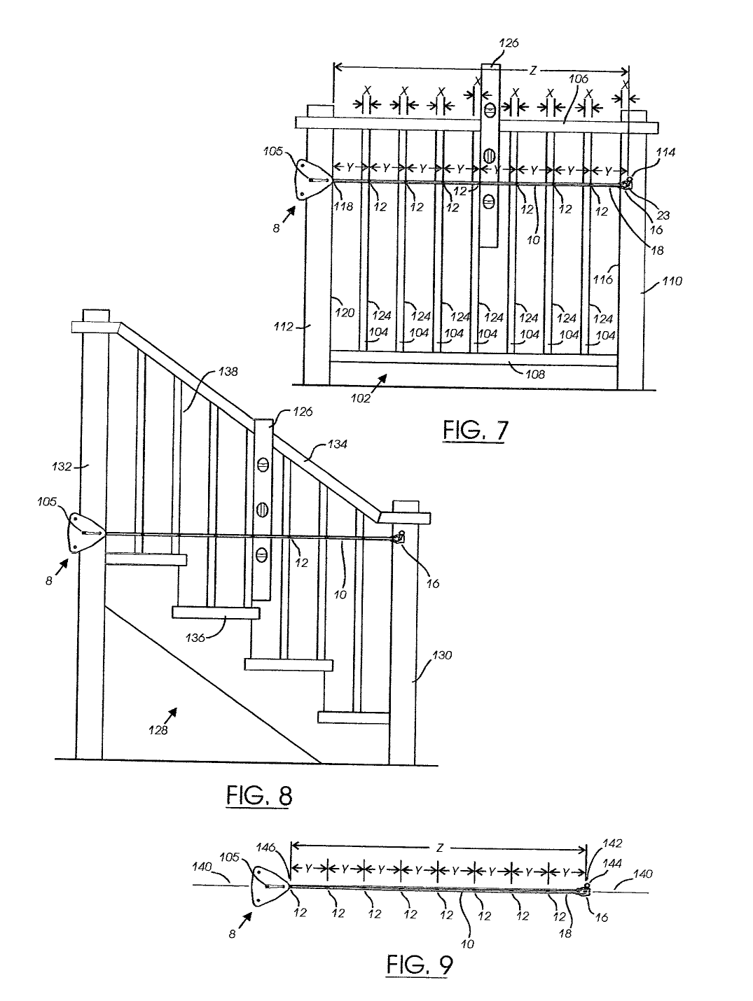

FIG. 7 is a plan view of the device of FIG. 3 with the pre-marked elastic cord stretched across a horizontal railing to be divided into one or more points equidistant from each other;

FIG. 8 is a plan view of the device of FIG. 3 with the pre-marked elastic cord stretched across a stairway railing to be divided into one or more points equidistant from each other; and

FIG. 9 is a plan view of the device of FIG. 3 with the pre-marked elastic cord stretched along a line to be divided into one or more points equidistant from each other.

### DETAILED DESCRIPTION OF THE DRAWINGS

Referring to the drawings, there is shown in FIG. 1 a spacing device 8 comprising a length of elastic cord 10 pre-marked with equally spaced indicia 12 in accordance with present invention. The device includes a reel 14 whereon the cord 10 is wound. The device 10 further includes a ringed hook 16 attached to the free end 18 of the cord 10 by way of a knot 20 that retains the cord 10 in the ringed hook 16 by a slot 22 in the hook 16. To ensure device accuracy, the knot 20 is formed at a point in the cord 10 whereby, when retained in slot 22, the distance from the outer hook portion 23 to the nearest mark 12 on the cord 10 is the same distance as that between each of the marks 12 on the cord 10.

The fastened end 24 of the cord 10 is led through a suitable hole 26 to the interior of the hub 28 and therein retained with a knot 30. The apparatus also includes a ringed skirt 32 adapted to be removably engaged to the reel 14 so as to securely encase the cord 10 and the ringed hook 16 within the reel 14. An outer surface 31 of the reel 14 is a suitable surface to affix notations of instructional nature. Both the reel 14 and the skirt 32 are adapted to be formed from plastic or other suitable material.

One or more apertures 33 are formed at the outer perimeter of each side of the reel 14 and are aligned on each side so that a fastening means, such as a finish nail 39, may pass through the reel 14.

A typical use of the device 8 of FIG. 1 is depicted in FIG. 2 wherein the ringed hook 16 is secured by a pin or nail 37 to a structure, and the cord 10 is unwound from the reel 14 of the spacing device 8. After the cord 10 is adjustably stretched so as to create the desired distance Y between any two indicia 12, the reel 14 may be secured to a working surface by a finish nail 39 passing through any of a pair of apertures 33 in the reel 14 so as to prevent the rotation of the reel 14 and to give the user freedom to access indicia 12 along the cord 10 in order to transfer their locations to a working surface.

A further embodiment is shown in FIG. 3, whereby a casing 34 encloses the device of FIG. 1. The casing 34 has a mating back portion 36 and a mating front portion 38, both of which are adapted to be formed from metal, plastic or other suitable material. The casing 34 is characterized by its equilateral triangular shape, each corner formed with blunt points 40, 42 and 44. The back portion 36 and the front portion 38 are so shaped that a circle may be inscribed in them, located at their centers.

The front portion 38 is provided with a boss 46, a boss 48, and a boss 50 on its interior side substantially within the three points 40, 42 and 44 respectively, shown in the sectional views of FIGS. 4, 5 and 6. Bosses 46, 48 and 50 are bored and tapped to be engageable by three screws 52, 54 and 56, respectively, which extend through three holes 58, 60 and 62, respectively, in the back portion 36. When the three screws 52, 54 and 56 are drawn tight, an effective securement of the mating back portion 36 and the front portion 38 of the casing 34 is established. As shown in FIG. 4, the back portion 36 is provided with a boss 66 on its interior side, substantially at its center.

An aperture 64 in the outer end of the first point 40 is formed when the back portion 36 and the front portion 38 are fully engaged.

A reel 68, having its hub 70 bored to receive the boss 66 is mounted within the casing 34 to rotate upon the boss 66 as an axis. The elastic cord 10 is wound upon the reel 68 and has its free end 18 led outwardly through the aperture 64, the free end 18 being provided with the ringed hook 16. The fastened end 24 of the cord 10 may be led through a suitable hole 72 to the interior of the hub 70 and there to be secured with a knot 74. Two spaces 76 and 78 formed between the reel 68 and the interior of the back portion 36 and the front portion 38, respectively, of a fully engaged casing 34 are of sufficient width so as to allow free rotation of the reel 68 on the boss 66, and yet to prevent the cord 10 from jumping the reel 68 and being caught between the reel 68 and the casing walls.

The hub 70 has an extension 80 adapted to extend outwardly through an opening 82 in the front portion 38. The outward end of the extension 80 pivotally supports a crank 84 at a hole 86 by which the reel 68 may be rotated to wind the cord 10. The crank 84 is pivoted to be swingable in planes perpendicular to the back portion 36 and is provided with a handle 88, which at end of the pivotal arcs is turned outwardly from the casing 34 and at the other end of the arcs is turned inwardly theretowards. The three bosses 46, 48 and 50 are provided with recesses 90, 92 and 94, respectively, closed at their inner ends and opening outwardly through the front portion 38. The crank 84 is of a suitable length to permit the handle 88 to enter the recesses 90, 92 and 94 when turned theretowards.

The reel 68 may be freed for rotation by swinging the crank 84 so that the handle 88 is positioned outwardly beyond the plane of the front portion 38. A desired length of the cord 10 may then be pulled from the aperture 64. When sufficient cord 10 is pulled from the aperture 64, a positive lock upon rotation of the reel 68 is provided by engagement of the handle 88 in any of the three recesses 90, 92 and 94. Three additional locking positions are also provided by engagement of the handle 88 with the side walls of casing 34. For example, if unwinding the cord 10 produces a counter-clockwise motion of the crank 84, best seen in FIG. 3, the rotation of the crank will be stopped at the three points 96, 98 and 100, where orbit of the handle 88 crosses the side walls of the casing 34, if the crank is swung pivotally to its locking inclination. Thus the length of the cord pulled from the casing 34 can be regulated to less than one-third of a turn of the cord upon the reel 68. Such exact regulation is often desirable when the cord 10 is stretched across a span to be divided into equally spaced points and it is desired to bring the precise point on the cord 10 into approximate contact with a point of securement.

Also shown in FIGS. 3 and 4 are two apertures 101 and 103 formed in the boss 66 and the extension 80 respectively and aligned centrally to the back portion 36 and the reel 68. Apertures 101 and 103 are formed so as to allow a fastening device, such as a finish nail 105, to pass through the device 8, thereby securing the device 8 to a working surface, as best shown in FIGS. 7, 8 and 9.

Shown in FIG. 7 is the device 8 of FIG. 3 applied to the task of dividing a railing frame 102 into one or more points equidistant from each other for the purpose of installing one or more vertical spindles 104. The pre-marked elastic cord 10 of the spacing device 8 is unwound across a span Z, such as a typical horizontal railing frame 102 formed by an upper rail 106 and a lower rail 108 secured to two vertical posts 110 and 112. The ringed hook 16 at the free end 18 of the cord 10 is attached to a nail 114 driven into the post 110 in a manner such that the outer hook portion 23 of the ringed hook 16 is aligned to the right of the left edge 116 of the post 110 by a distance X. Distance X is also shown as the width of one or more spindles 104 to be vertically affixed equidistant from each other to the rails 106 and 108. The length of the elastic cord 10 unwound from the spacing device 8 and parallel to the upper railing 106 discloses one or more equally spaced indicia 12 pre-marked on the cord 10. When the cord 10 is stretched in a manner sufficient to disclose the same amount of indicia 12 as the number of spindles 104 desired to be installed within the span Z, the mark, shown as mark 118 nearest to the post 112, is brought into alignment with the right edge 120 of the post 112, and the device 8 is secured to the post 112 with a nail 105 passing through the two apertures 103 and 101 in the center of the device 8.

Further regulation of the tension of the cord 10 and the spacing of the indicia 12 thereon is provided by rotating the crank 84 to the desired position and engaging and locking the handle 88 into any of the three recesses 90, 92 or 94 or other positions previously described.

Due to the indicia 12 being pre-marked on a cord 10 that is elastic in character, each indicia 12 within the span Z is separated by equal spacings Y. Each indicia 12 marks the precise location of the right edge 124 of the spindles 104 to be installed. The location of each indicia 12 can be transferred to the upper rail 106 or the lower rail 108, and the spindles 104 can then be accurately and quickly installed with the aid of a carpenter's level 126.

Whereas in FIG. 7 the spacing device 8 is applied to the task of dividing a horizontal railing frame 102 into one or more points equidistant from each other, a similar application of the spacing device 8 is shown in FIG. 8 wherein a set of stairs 128 is depicted having two posts 130 and 132, a hand rail 134, and the stair treads 136. As in FIG. 7, the pre-marked elastic cord 10 of the spacing device 8 is stretched perpendicular to and horizontally between the two posts 130 and 132 to indicate by the indicia 12 the precise locations for the placement of one or more of the spindles 138. As in FIG. 7, the installation of the spindles 138 is facilitated with the aid of a carpenter's level 126.

As shown in FIG. 9, a highly desirable feature of the invention resides in the provision of a pre-marked elastic cord 10 on which equally spaced indicia 12 are stretchably adjustable along a straight line 140 when a quick and accurate indication of equally spaced points set apart by a distance Y is required. The ringed hook 16 on the free end 18 of the cord 10 is secured at one end 142 of line 140 by a pin or nail 144 and the cord 10 is unwound from the spacing device 8 and laid parallel to and in the proximity of the line 140. The cord 10 is stretched until the desired distance Y between the two indicia 12 nearest to the device 8 is met. With distance Y established, the nearest indicia 12 to the device 8 is secured at a point 146 on the line 140 by a finish nail 105 driven into the working surface.

As with the device 8 of FIGS. 7 and 8, further regulation of the tension of the cord 10 and the spacing of the indicia 12 thereon is provided by rotating the crank 84 to the desired position and engaging and locking the handle 88 into any of the three recesses 90, 92 or 94 or other positions previously described.

Due to the evenly stretching character of the elastic cord 10, each indicia 12 along its length is spaced equally apart from one another by that same distance Y, and their location can be transferred to the line 140. Also, due to the stretching character of the elastic cord 10, the distance Y may be any one of many dimensions, the number of which is limited only to the elastic scope of the cord 10. Thus, one or more equally spaced points can be established along a line 140, and that spacing is quickly and stretchably adjustable to suit the user's spacing requirements.

From the foregoing description it will be readily apparent that there is shown and described in accordance with the invention a novel spacing device having a length of elastic cord pre-marked with equally spaced indicia. When stretched across a given span to be divided into equal spaces, the distance between any two marks will be equal to the distance between each of the marks on the cord within the span, thereby providing a quick reference of one or more equally spaced points within a given span. When dividing a given span by a given number of spaces, the pre-marked cord can be adjusted elastically to provide the location of one or more points equally dividing that span. When locating equally spaced points along a line, the pre-marked cord can be adjusted elastically to establish the desired spacing and provide the location of those points.

It must be understood that the form of the present invention as described herein is to be taken as a representative embodiment of the same and that changes may be made in the shape, size, material and configuration without departing from the spirit and the scope of the invention. Thus, the invention is to be limited only by the scope of the claims that follow and the equivalents thereof.

The embodiments of the invention in which an exclusive property or privilege is claimed are defined as follows:

1. A spacing device, comprising:
a length of elastic cord;
a plurality of equally spaced indicia formed on said cord; and
a ringed hook to fasten one end of said cord to a fixed point.

2. The spacing device of claim 1, wherein said elastic cord is stored on a reel.

3. The spacing device of claim 1, wherein an outer perimeter of said reel is formed with one or more apertures aligned so as to allow passage of a fastening means to secure said reel to a surface and to prevent its rotation.

4. The spacing device of claim 2, wherein said reel is rotatably mounted in a dispensing and storage casing of generally triangular configuration comprising:
a pair of opposed mating side members defining a reel chamber having a generally circular center portion and three generally pointed ends and having longitudinally extending mating surfaces, said mating surfaces provided with apertures formed so as to receive a removable fastening means thereby, to engage said mating surfaces, and to prevent separation thereof;
one of said pointed ends having an aperture through which said cord mounted on said reel extends from said chamber;
said circular portion having a center, the axis of said reel being substantially at said center;
a well formed in each of said pointed ends in one of said side members;
a crank for rotating said reel hingedly connected to said reel for arcuate movement in planes perpendicular to said sides and having a handle extending outwardly from said casing when said crank is at one end of said arcuate movement, and inwardly toward said casing at the other end of said movement, said crank having a length sufficient to permit said handle to rotate in a circle, said wells being disposed on said circle and adapted to receive said handle; and
said center of said reel chamber and said reel having apertures through which a fastening means may be passed to secure said reel chamber to a working surface yet allow rotation of said reel in said reel chamber.

5. A device for determining spacing, comprising:
a uniformly stretchable, flexible filament having a plurality of equally-spaced indicia formed thereon so that stretching of the filament between any two points results in equidistant spacing of the indicia to enable marking of uniformly-sized spaces along the distance between the two points.

6. The device of claim 5, comprising a device for affixing one end of the filament.

7. The device of claim 6, comprising a reel affixed the other end of the filament and configured to receive the filament in winding engagement.

8. The device of claim 7, wherein the reel has an outer perimeter with at least one aperture to enable secure affixation of the reel and to prevent rotation of the reel.

9. The device of claim 7, wherein the reel is rotatably mounted in a dispensing and storage casing of generally triangular configuration comprising:
a pair of opposed mating side members defining a reel chamber having a generally circular center portion and three generally pointed ends and having longitudinally extending mating surfaces, said mating surfaces provided with apertures formed so as to receive a removable fastening means thereby, to engage said mating surfaces, and to prevent separation thereof;
one of said pointed ends having an aperture through which said cord mounted on said reel extends from said chamber;
said circular portion having a center, the axis of said reel being substantially at said center;
a well formed in each of said pointed ends in one of said side members;
a crank for rotating said reel hingedly connected to said reel for arcuate movement in planes perpendicular to said sides and having a handle extending outwardly from said casing when said crank is at one end of said arcuate movement, and inwardly toward said casing at the other end of said movement, said crank having a length sufficient to permit said handle to rotate in a circle, said wells being disposed on said circle and adapted to receive said handle; and
said center of said reel chamber and said reel having apertures through which a fastening means may be passed to secure said reel chamber to a working surface yet allow rotation of said reel in said reel chamber.
